(19) United States
(12) Patent Application Publication
(10) Pub. No.: US 2024/0117148 A1
(43) Pub. Date: Apr. 11, 2024

(54) THERMALLY CONDUCTIVE SHEET, THERMALLY CONDUCTIVE SHEET SUPPLY FORM, THERMALLY CONDUCTIVE SHEET PRECURSOR, AND METHOD FOR MANUFACTURING THERMALLY CONDUCTIVE SHEET

(71) Applicant: DEXERIALS CORPORATION, Shimotsuke-shi, Tochigi (JP)

(72) Inventors: Keisuke ARAMAKI, Shimotsuke-shi, Tochigi (JP); Yuma SATO, Shimotsuke-shi, Tochigi (JP); Yusuke KUBO, Shimotsuke-shi, Tochigi (JP)

(73) Assignee: DEXERIALS CORPORATION, Shimotsuke-shi, Tochigi (JP)

(21) Appl. No.: 18/275,450

(22) PCT Filed: Jan. 28, 2022
(86) PCT No.: PCT/JP2022/003281

§ 371 Date: Aug. 2, 2023

(30) Foreign Application Priority Data
Feb. 10, 2021 (JP) 2021-020252

(51) Int. Cl. C08K 3/38; C08L 101/00

(52) U.S. Cl. CPC C08K 3/38; C08L 101/00; C08K 2003/385; C08K 2201/001; C08L 2203/20

(57) ABSTRACT

A thermally conductive sheet includes a binder resin and boron nitride flakes. The boron nitride flakes are oriented in a thickness direction of the thermally conductive sheet, and both surfaces of the thermally conductive sheet are tacky. A method for manufacturing a thermally conductive sheet includes preparing a thermally conductive composition containing a binder resin and boron nitride flakes. A molded block is formed from the thermally conductive composition. The molded block is sliced into a sheet shape to obtain a thermally conductive sheet precursor. The thermally conductive sheet precursor is pressed to obtain a thermally conductive sheet.

### TECHNICAL FIELD

The present art relates to a supply form of a thermally conductive sheet and to a thermally conductive sheet. The present application claims priority based on Japanese Patent Application No. 2021-020252 filed in Japan on Feb. 10, 2021, which application is incorporated into the present application by reference.

### BACKGROUND ART

As electronic devices become more sophisticated, semiconductor devices are becoming denser and more complex. In line with this, it is important to more efficiently dissipate heat generated from electronic components that constitute electronic devices. For example, in semiconductor devices, electronic components are attached to dissipation fans and heat sinks such as heat dissipation plates through thermally conductive sheet in order to dissipate heat efficiently. For example, thermally conductive sheets in which fillers such as inorganic fillers are contained (dispersed) in a silicone resin are widely used. Further improvement of thermal conductivity is required for thermally conductive members such as these thermally conductive sheets. For example, increasing the filler content of inorganic fillers mixed in a matrix such as a binder resin for the purpose of high thermal conductivity in thermally conductive sheets has been considered. However, increasing the filler content causes loss of flexibility and crumbling of the thermally conductive sheet, and thus there is a limit to increasing the filler content of inorganic filler.

Examples of inorganic fillers include alumina, aluminum nitride, aluminum hydroxide, and the like Furthermore, flakes such as boron nitride or graphite, carbon fiber, or the like may also be added into the matrix for high thermal conductivity. This is due to the anisotropy of thermal conductivity of flakes and the like. For example, carbon fiber is known to have a thermal conductivity of about 600 to 1200 W/m·K in the direction of the fibers. Furthermore, boron nitride is known to have a thermal conductivity of about 110 W/m·K in the surface direction and about 2 W/m·K in the direction perpendicular to the surface direction.

Patent document 1 teaches a thermally conductive sheet containing boron nitride. Such thermally conductive sheets are obtained, for example, by preparing a molded block from a resin composition for forming thermally conductive sheets and slicing the molded block. However, when the molded block is sliced in this way to produce a thermally conductive sheet, the surface of the thermally conductive sheet is not tacky. When the surface of the thermally conductive sheet is not tacky, the thermally conductive sheet cannot be attached to the adherend, and misalignment may occur when the thermally conductive sheet is mounted.

### CITATION LIST

### Patent Documents

Patent Document 1: WO 2019/026745

### SUMMARY OF INVENTION

### Problem to be Solved by Invention

The present art is proposed in view of such conventional conditions and provides a thermally conductive sheet having a tacky surface.

### Means for Solving Problem

The thermally conductive sheet according to the present art contains a binder resin and boron nitride flakes, the boron nitride flakes are oriented in a thickness direction of the thermally conductive sheet, and both sides of the thermally conductive sheet are tacky.

The method for producing a thermally conductive sheet according to the present art has a step A for preparing a thermally conductive composition containing a binder resin and boron nitride flakes, a step B for forming a molded block from the thermally conductive composition, a step C for slicing the molded block into sheet form to obtain a thermally conductive sheet precursor, and a step D for pressing the thermally conductive sheet precursor to obtain a thermally conductive sheet.

### Effect of Invention

According to the present art, it is possible to provide a thermally conductive sheet having a tacky surface.

### BRIEF DESCRIPTION OF DRAWINGS

FIG. 1 is a sectional view illustrating one example of the thermally conductive sheet.

FIG. 2 is a perspective view schematically illustrating boron nitride flakes having a hexagonal crystal shape.

FIG. 3 is a sectional view illustrating one example of the supply form of a thermally conductive sheet.

FIG. 4 is a sectional view for describing one example of step D in the method for manufacturing a thermally conductive sheet, the step being for pressing a thermally conductive sheet precursor to obtain a thermally conductive sheet.

FIG. 5 is a sectional view for describing one example of step D in the method for manufacturing a thermally conductive sheet, the step being for pressing a thermally conductive sheet precursor to obtain a thermally conductive sheet.

FIG. 6 is a sectional view illustrating one example of a semiconductor device to which a thermally conductive sheet is applied.

FIG. 7 is a diagram for describing a method for evaluating whether the thermally conductive sheet slides down an aluminum plate when placing a thermally conductive sheet on the aluminum plate, and tilting by 90°.

### EMBODIMENTS OF INVENTION

In the present Specification, the average particle size (D50) of boron nitride flakes and thermally conductive materials refers to, for example, the particle size when the entire particle size distribution of the boron nitride flakes or thermally conductive material is set to 100%, the cumulative curve of particle diameter values is obtained from the small particle size side of the particle diameter distribution, and the cumulative value is 50%. Note that granularity distribution (particle size distribution) in the present Specification is found on a volumetric basis. Granularity distribution can be measured, for example, using a laser diffraction granularity distribution analyzer.

The thermally conductive sheet according to the present art contains a binder resin and boron nitride flakes, the boron nitride flakes are oriented in a thickness direction of the thermally conductive sheet, and both sides of the thermally conductive sheet are tacky. The thermally conductive sheet of the present art thus has a tacky surface which allows the thermally conductive sheet to be attached to the adherend and can prevent misalignment of the thermally conductive sheet during mounting.

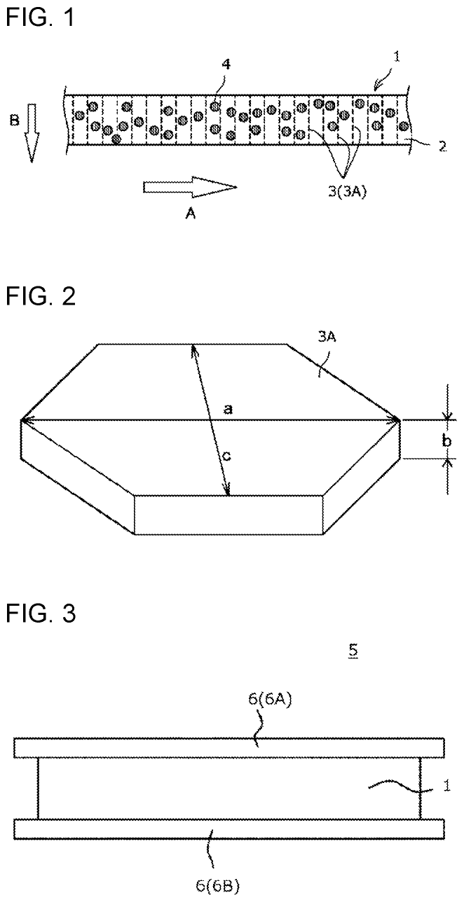

FIG. 1 is a sectional view illustrating one example of the thermally conductive sheet. A thermally conductive sheet 1 contains a binder resin 2 and boron nitride flakes 3, the boron nitride flakes 3 being oriented in a thickness direction B of the thermally conductive sheet 1. In other words, a surface direction of the boron nitride flakes 3 (for example, the long axis of the boron nitride 3) of the thermally conductive sheet 1 may be oriented in the thickness direction B of the thermally conductive sheet 1. Furthermore, the thermally conductive sheet 1 may further contain another thermally conductive material 4 aside from the boron nitride flakes 3. Specific examples of the constituent elements of the thermally conductive sheet 1 are described below.

<Binder Resin>

The binder resin 2 is used to hold the boron nitride flakes 3 and the other thermally conductive material 4 within the thermally conductive sheet 1. The binder resin 2 is selected according to mechanical strength, heat resistance, electrical properties, and other characteristics required for the thermally conductive sheet 1. The binder resin 2 may be selected from thermoplastic resins, thermoplastic elastomers, and thermosetting resins.

Examples of thermoplastic resins include polyethylene, polypropylene, ethylene/α-olefin copolymers such as ethylene-propylene copolymers, polymethylpentene, polyvinyl chloride, polyvinylidene chloride, polyvinyl acetate, ethylene-vinyl acetate copolymers, polyvinyl alcohol, polyvinyl acetal, fluorine-based polymers such as polyvinylidene fluoride and polytetrafluoroethylene, polyethylene terephthalate, polybutylene terephthalate, polyethylene naphthalate, polystyrene, polyacrylonitrile, styrene-acrylonitrile copolymers, acrylonitrile-butadiene-styrene copolymer (ABS) resins, polyphenylene-ether copolymer (PPE) resins, modified PPE resins, aliphatic polyamides, aromatic polyamides, polyimide, polyamideimide, polymethacrylic acid, polymethacrylic acid esters such as polymethacrylic acid methyl ester, polyacrylic acids, polycarbonate, polyphenylene sulfide, polysulfone, polyether sulfone, polyether nitrile, polyetherketone, polyketone, liquid crystal polymer, silicone resin, ionomer, and the like.

Examples of thermoplastic elastomers include styrene-butadiene block copolymers or hydrogenated products thereof, styrene-isoprene block copolymers or hydrogenated product thereof, styrene thermoplastic elastomers, olefin thermoplastic elastomers, vinyl chloride thermoplastic elastomers, polyester thermoplastic elastomer, polyurethane thermoplastic elastomers, polyamide thermoplastic elastomers, and the like.

Examples of thermosetting resins include cross-linked rubbers, epoxy resins, phenol resins, polyimide resins, unsaturated polyester resins, diallyl phthalate resins, and the like. Specific examples of cross-linked rubbers include natural rubber, acrylic rubber, butadiene rubber, isoprene rubber, styrene-butadiene copolymer rubber, nitrile rubber, hydrogenated nitrile rubber, chloroprene rubber, ethylene-propylene copolymer rubber, chlorinated polyethylene rubber, chlorosulfonated polyethylene rubber, butyl rubber, halogenated butyl rubber, fluoro rubber, urethane rubber, and silicone rubber.

For example, silicone resin is preferable as the binder resin 2 in consideration of adhesion between the heat-generating surface of an electronic component and the heat sink surface. For example, a two-component addition-reaction silicone resin which is composed of a main agent which includes silicone having alkenyl groups as a main component and a curing catalyst, and a curing agent having hydrosilyl groups (Si—H groups) may be used as the silicone resin. For example, a polyorganosiloxane having vinyl groups may be used as the silicone having alkenyl groups. The curing catalyst is a catalyst for promoting an addition reaction between the alkenyl groups in the silicone having alkenyl groups and the hydrosilyl groups in the curing agent having hydrosilyl groups. Examples of the curing catalyst include well-known catalysts used in hydrosilylation reactions. For example, platinum group curing catalysts, such as platinum group metals in isolation, including platinum, rhodium, and palladium, and platinum chloride, or the like, may be used. For example, a polyorganosiloxane having hydrosilyl groups may be used as the curing agent having hydrosilyl groups. One type of binder resin 2 may be used in isolation, or two or more types may be used in combination.

The content of the binder resin 2 in the thermally conductive sheet 1 is not particularly limited and may be selected as appropriate according to the purpose. For example, from the perspective of flexibility of the thermally conductive sheet 1, the content of the binder resin 2 in the thermally conductive sheet 1 may be 20% or more by volume, 25% or more by volume, 30% or more by volume, or 33% or more by volume. Furthermore, from the perspective of thermal conductivity of the thermally conductive sheet 1, the content of binder resin 2 in the thermally conductive sheet 1 may be 70% or less by volume, 60% or less by volume, 50% or less by volume, 40% or less by volume, or 37% or less by volume. For example, from the perspective of flexibility of the thermally conductive sheet 1, the content of the binder resin 2 in the thermally conductive sheet 1 is preferably 25 to 60% by volume and may be 30 to 40% by volume or 33 to 37% by volume.

<Boron Nitride Flakes>

The thermally conductive sheet 1 contains the boron nitride flakes 3. The boron nitride flakes 3 means a boron nitride having a major axis, a minor axis, and a thickness, having a high aspect ratio (major axis/thickness), and having a thermal conductivity that is isotropic in a surface direction containing the major axis. The minor axis refers to, in the plane containing the major axis of the boron nitride flakes 3, a direction intersecting the major axis at a substantially central portion of a particle of the boron nitride flakes 3, being the length of the shortest portion of the boron nitride flakes 3. The thickness refers to the average value of 10 μmeasurements of the thickness of the plane containing the major axis of the boron nitride flakes 3. One type of boron nitride flakes 3 may be used in isolation, or two or more types may be used in combination.

FIG. 2 is a perspective view schematically illustrating a boron nitride flake 3A having a hexagonal crystal shape, which is one example of the boron nitride flakes. In FIG. 2, a indicates the major axis of the boron nitride flake 3A, b indicates the thickness of the boron nitride flake 3A, and c indicates the minor axis of the boron nitride flake 3A. From the perspective of thermal conductivity of the thermally conductive sheet 1, it is preferable to use the boron nitride flakes 3A having a hexagonal crystal shape as illustrated in FIG. 2 as the boron nitride flakes 3.

The average particle size (D50) of boron nitride flakes 3 is not particularly limited and may be selected as appropriate according to the purpose. For example, the average particle size of the boron nitride flakes 3 may be 10 μm or larger, 20 μm or larger, 30 μm or larger, or 35 μm or larger. Furthermore, the upper limit of the average particle size of the boron nitride flakes 3 may be 150 μm or less, 100 μm or less, 90 m or less, 80 μm or less, 70 μm or less, 50 μm or less, or 45 μm or less. From the perspective of thermal conductivity of the thermally conductive sheet 1, the average particle size of the boron nitride flakes 3 is preferably 20 to 100 μm. The aspect ratio of the boron nitride flakes 3 is not particularly limited and may be selected as appropriate according to the purpose. For example, the aspect ratio of boron nitride flakes 3 may be a range of 10 to 100. The average value of the ratio of the major axis to the minor axis (major axis/minor axis) of the boron nitride flakes 3 may, for example, be a range of 0.5 to 10, a range of 1 to 5, or a range of 1 to 3.

The content of the boron nitride flakes 3 in the thermally conductive sheet 1 is not particularly limited and may be selected as appropriate according to the purpose. For example, from the perspective of thermal conductivity of the thermally conductive sheet 1, the content of the boron nitride flakes 3 in the thermally conductive sheet 1 may be 15% or more by volume, 20% or more by volume, or 23% or more by volume. Furthermore, from the perspective of the flexibility of the thermally conductive sheet 1, the upper limit of the content of boron nitride flakes 3 in the thermally conductive sheet 1 may be, for example, 45% or less by volume, 40% or less by volume, 35% or less by volume, or 30% or less by volume. From the perspective of thermal conductivity of the thermally conductive sheet 1, the content of the boron nitride flakes 3 in the thermally conductive sheet 1 is preferably 20 to 35% by volume, more preferably 20 to 30% by volume, and further preferably 23 to 27% by volume.

<Other Thermally Conductive Material>

The other thermally conductive material 4 is a thermally conductive material other than the boron nitride flakes 3 described above. The shape of the other thermally conductive material 4 may be, for example, spherical, powdery, granular, flat, fibrous, or the like. One type of the other thermally conductive material 4 may be used in isolation, or two or more types may be used in combination.

For example, from the perspective of ensuring insulation of the thermally conductive sheet 1, aluminum oxide (alumina, sapphire), aluminum nitride, zinc oxide, aluminum hydroxide, and the like, may be used as the other thermally conductive material 4. Furthermore, from the perspective of thermal conductivity of the thermally conductive sheet 1, an embodiment wherein aluminum nitride particles and alumina particles are used in combination or an embodiment wherein aluminum nitride particles, alumina particles, zinc oxide, and aluminum hydroxide are used in combination is preferable as the other thermally conductive material 4. The average particle size (D50) of the aluminum nitride particles may be, for example, 1 to 5 μm, 1 to 3 μm, or 1 to 2 μm. Furthermore, the average particle size (D50) of the alumina particles may be, for example, 0.1 to 10 μm, 0.1 to 8 μm, 0.1 to 7 μm, or 0.1 to 2 am. The average particle size (D50) of the zinc oxide particles may be, for example, 0.1 to 5 μm, 0.5 to 3 μm, or 0.5 to 2 μm. The average particle size (D50) of the aluminum hydroxide particles may be, for example, 1 to 10 μm, 2 to 9 μm, or 6 to 8 μm.

The content of the other thermally conductive material 4 in the thermally conductive sheet 1 is not particularly limited and may be selected as appropriate according to the purpose. From the perspective of thermal conductivity of the thermally conductive sheet 1, the content of the other thermally conductive material 4 in the thermally conductive sheet 1 may be 10% or more by volume, 15% or more by volume, 20% or more by volume, 25% or more by volume, 30% or more by volume, or 35% or more by volume. Furthermore, from the perspective of flexibility of the thermally conductive sheet 1, the content of the other thermally conductive material 4 in the thermally conductive sheet 1 may be 50% or less by volume, 45% or less by volume, or 40% or less by volume.

When using aluminum nitride particles and alumina particles in combination as the other thermally conductive material 4, within the thermally conductive sheet 1, the content of the alumina particles is preferably 10 to 25% by volume, and the content of the aluminum nitride particles is preferably 10 to 25% by volume. Furthermore, when using aluminum nitride particles, alumina particles, zinc oxide particles, and aluminum hydroxide particles in combination as the other thermally conductive material 4, within the thermally conductive sheet 1, the content of the alumina particles is preferably 10 to 25% by volume, the content of the aluminum nitride particles is preferably 10 to 25% by volume, the content of the zinc oxide particles is preferably 0.1 to 3% by volume, and content of the aluminum hydroxide particles is preferably 0.1 to 3% by volume.

The thermally conductive sheet 1 may further contain other components aside from the components described within a scope that does not impair the effect of the present art. Examples of other components include silane coupling agents (coupling agents), dispersants, curing accelerators, retardants, tackifiers, plasticizers, flame retardants, antioxidants, stabilizers, and colorants. For example, from the perspective of further improving dispersion of the boron nitride flakes 3 and the other thermally conductive material 4 and further improving the flexibility of the thermally conductive sheet 1, the boron nitride flakes 3, having been treated with a silane coupling agent, and/or the other thermally conductive material 4, having been treated with a silane coupling agent, may be used in the thermally conductive sheet 1.

The thickness of the thermally conductive sheet 1 is not particularly limited and may be selected as appropriate according to the purpose. For example, the thickness of the thermally conductive sheet 3 may be 0.05 μmm or more or 0.1 μmm or more. Furthermore, the upper limit of the thickness of the thermally conductive sheet 1 may be 5 μmm or less, 4 μmm or less, or 3 μmm or less. From the perspective of ease of handling, the thermally conductive sheet 1 preferably has a thickness of 0.1 to 4 μmm. For example, the thickness of the thermally conductive sheet 3 can be found from the arithmetic mean value of five measurements of the thickness of the thermally conductive sheet 1 at five arbitrary locations.

The lower the specific gravity of the thermally conductive sheet 1 is, the more preferable it is in terms of weight reduction of electronic components. For example, the thermally conductive sheet 1 may have a specific gravity of 2.7 or less, 2.6 or less, 2.5 or less, 2.4 or less, or 2.3 or less. Furthermore, the thermally conductive sheet 1 may have a specific gravity of 2.0 or more, 2.1 or more, or 2.2 or more. The specific gravity of the thermally conductive sheet 1 can be measured by the method given in the examples described later.

The thermally conductive sheet 1 may have a regular surface pattern. By giving the thermally conductive sheet 1 a regular surface pattern, it is possible to easily distinguish from the other thermally conductive sheet by appearance. Furthermore, by giving the thermally conductive sheet 1 a regular pattern, for example, when attached to an adherend, it is possible to prevent air from being encapsulated between the thermally conductive sheet and the adherend, and it is possible to more reliably attach the thermally conductive sheet to the adherend. Thus, it is possible to improve close adhesion of the thermally conductive sheet when mounted. The regular pattern is a visible pattern, and examples include geometric patterns such as polygons having non-orthogonal sides, patterns in which a plurality of circles and ellipses are contiguous, or a pattern combining such geometric patterns and circular and elliptical patterns.

FIG. 3 is a sectional view illustrating one example of the supply form of a thermally conductive sheet. As illustrated in FIG. 3, the thermally conductive sheet 1 may also be configured as a thermally conductive sheet supply form 5 sandwiched by a release film 6. For example, the thermally conductive sheet supply form 5 may be a laminate provided with a release film 6A, the thermally conductive sheet 1, and a release film 6B, in that order. In other words, in the thermally conductive sheet supply form 5, the release film 6 is provided on both sides of a single thermally conductive sheet 1. Furthermore, in the thermally conductive sheet supply form 5, the release film 6 may be provided on both sides of a plurality of thermally conductive sheets 1 disposed at predetermined intervals laterally and longitudinally.

The thermally conductive sheet supply form 5 preferably has a tack force of 20 gf or more as measured under the following conditions, which may be 75 gf or more or 80 gf or more.

Measurement method: Press-treat thermally conductive sheet 1 sandwiched by release film 6 (thermally conductive sheet supply form 5) at 0.5 MPa for 30 seconds, and within three minutes after removing the release film 6 from the thermally conductive sheet 1, press thermally conductive sheet 1 in 50 μm at 2 μmm/second using a 5.1 μmm diameter probe and pull out at 10 μmm/second.

The release film 6 may be PET (polyethylene terephthalate), PEN (polyethylene naphthalate), polyolefin, polymethylpentene, glassine paper, or the like. The thickness of the release film 6 is not particularly limited and may be selected as appropriate according to the purpose. For example, it may be 5 to 200 μm. Furthermore, the thinner the release film 6 is, the better the tracking (close adhesion) to the thermally conductive sheet 1 becomes, and the more effectively the tackiness of the thermally conductive sheet 1 can be expressed. For example, from the perspective of more effectively expressing the tackiness of the thermally conductive sheet 1, the release film 6 is preferably a thin PET film. The release film 6A and the release film 6B may be made of the same material or of different materials. Furthermore, the release film 6A and the release film 6B may have the same thickness or different thicknesses.

Next, a method for manufacturing the thermally conductive sheet 1 will be described. The method for manufacturing the thermally conductive sheet 1 has a step A for preparing a thermally conductive composition, a step B for forming a molded block from the thermally conductive composition, a step C for slicing the molded block into a sheet shape to obtain a thermally conductive sheet precursor, and a step D for pressing the thermally conductive sheet precursor to obtain a thermally conductive sheet.

In step A, a thermally conductive composition containing the binder resin 2 and the boron nitride flakes 3 is prepared. The thermally conductive composition may further contain another thermally conductive material 4 in addition to the binder resin 2 and the boron nitride flakes 3. The thermally conductive composition may be uniformly mixed with various additives or volatile solvents by known techniques. As one embodiment of step A, a thermally conductive composition in which the boron nitride flakes 3 and the other thermally conductive material 4 are dispersed in the binder resin 2 is prepared.

In step B, a molded block is formed from the thermally conductive composition prepared in step A. Examples of the method for forming the molded block include extrusion molding, die molding, and the like. The extrusion molding and die molding methods are not particularly limited and may be adopted as appropriate from among various known extrusion molding and die molding methods according to the viscosity of the thermally conductive composition, the properties required of the thermally conductive sheet, and the like.

For example, when extruding the thermally conductive composition from a die in extrusion molding, or when pressing the thermally conductive composition into a mold in die molding, the binder resin 2 flows, and the boron nitride flakes 3 are oriented in the direction of the flow thereof.

The size and shape of the molded block may be determined according to the required size of the thermally conductive sheet 1. Examples include a rectangular object having a cross section of 0.5 to 15 cm in vertical size and 0.5 to 15 cm in horizontal size. The length of the rectangle may be determined as needed. In extrusion molding, a columnar molded block composed of a cured product of the thermally conductive composition and in which a surface direction of the boron nitride flakes 3 (major axis a of the boron nitride flakes) is oriented in the extrusion direction is easily formed.

In step C, the molded block is sliced into a sheet shape to obtain a thermally conductive sheet precursor 7. The surface (sliced face) of the thermally conductive sheet precursor obtained by slicing exposes the boron nitride flakes 3. The method for slicing is not particularly limited and may be selected as appropriate from known slicing devices (preferably an ultrasonic cutter) according to the size and mechanical strength of the molded block. The slicing direction of the molded block may be, when the molding method is extrusion molding, preferably 60 to 120° with respect to the extrusion direction, more preferably a 70 to 100° direction, and further preferably a 90° (perpendicular) direction, since some are oriented in the extruding direction. When a columnar molded block is formed by extrusion molding in step B, in step C, it is preferable to slice in a direction substantially perpendicular to the length direction of the molded block.

In step D, the thermally conductive sheet precursor 7 is pressed to obtain the thermally conductive sheet 1. Specifically, in step D, the sliced face of the thermally conductive sheet precursor 7 is pressed. Thus, by pressing the thermally conductive sheet precursor 7 obtained in step C, a thermally conductive sheet 1 containing the binder resin 2 and the boron nitride flakes 3 in which the boron nitride flakes 3 are oriented in the thickness direction B of the thermally conductive sheet 1 and which is tacky is obtained. Thus, the thermally conductive sheet 1 obtained in step D is tacky on both sides, which can prevent misalignment during mounting of the thermally conductive sheet 1.

In step D, by pressing the thermally conductive sheet precursor 7 obtained in step C, the binder resin 2 constituting the thermally conductive sheet precursor 7 seeps out onto the surface of the thermally conductive sheet 1 (thermally conductive sheet precursor 7 after pressing), and the thermally conductive sheet becomes tacky. The binder resin 2 that seeps out onto the surface of the thermally conductive sheet 1 may be in an uncured state or may be cured to a degree of several percent.

Furthermore, the surface of the thermally conductive sheet 1 obtained in step D may be smoothened more and adhesion between the thermally conductive sheet 1 and other members is improved.

A pair of presses having a flat plate and a press head having a flat surface may be used to press the thermally conductive sheet precursor 7. The thermally conductive sheet precursor 7 may also be pressed with a pinch roll. The pressure during pressing may be, for example, a range of 0.1 to 100 MPa, a range of 0.1 to 1 MPa, or a range of 0.1 to 0.5 MPa. To further increase the pressing effect and reduce pressing time, pressing may be performed at or above the glass transition temperature (Tg) of the binder resin 2 constituting the thermally conductive sheet precursor 7. For example, the press temperature may be a range of 0 to 180° C., a range of room temperature (for example 25° C.) to 100° C., or a range of 30 to 100° C. For example, the pressing time may be a range of 10 seconds to 5 μminutes or a range of 30 seconds to 3 μminutes. For example, from the perspective of effectively expressing the tackiness of the thermally conductive sheet 1, the pressure during pressing is preferably a range of 0.3 to 0.6 MPa, and the pressing temperature is preferably a range of 60 to 100° C.

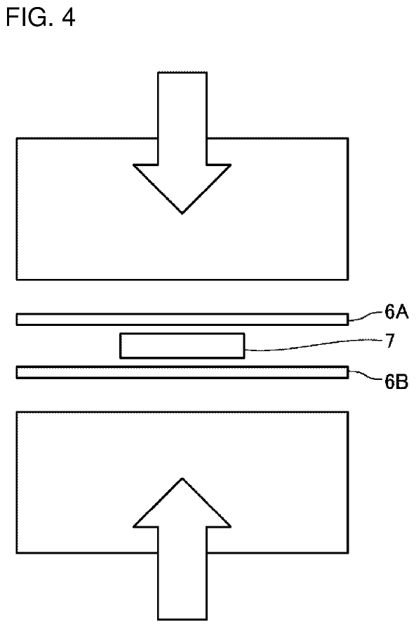

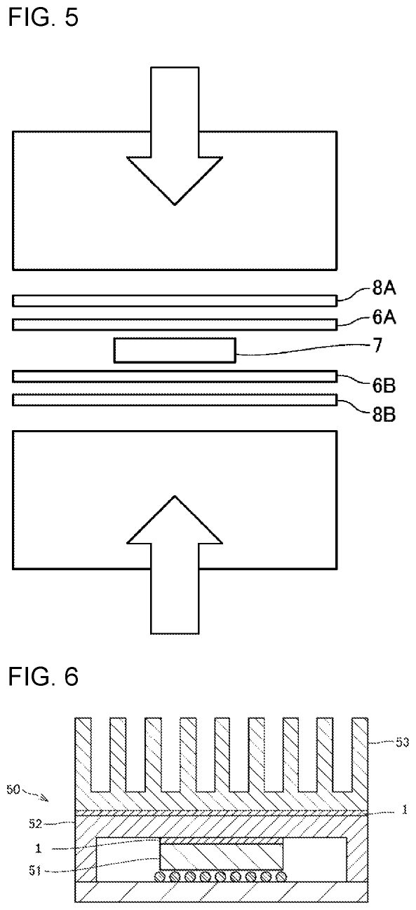

FIGS. 4 and 5 are each sectional views for describing one example of step D in the method for manufacturing a thermally conductive sheet, the step being for pressing a thermally conductive sheet precursor to obtain a thermally conductive sheet. The arrows in FIGS. 4 and 5 indicate the direction of the pressing. In step D, pressing may be performed while the thermally conductive sheet precursor is sandwiched by the release film 6, that is, on a laminate of the release film 6A, the thermally conductive sheet precursor 7, and the release film 6B, as illustrated in FIG. 4. Thus, it is possible to prevent the thermally conductive sheet precursor 7 from adhering to the pressing device when pressing the thermally conductive sheet precursor 7.

In step D, a film having regular surface unevenness may be used as the release film 6 illustrated in FIG. 4. Thus, in addition to obtaining a thermally conductive sheet 1 on which a regular surface pattern such as is described above is formed, tracking (close adhesion) of the release film 6 to the thermally conductive sheet 1 becomes more favorable, and it is possible to effectively express the tack force of the thermally conductive sheet 1. Furthermore, it is also possible to prevent the thermally conductive sheet precursor 7 from adhering to the pressing device when pressing the thermally conductive sheet precursor 7. Regular surface unevenness means a shape that can form the regular pattern described above on the thermally conductive sheet 1, and examples of the shape of concave portions or convex portions in a plan view include geometric patterns such as polygons having non-orthogonal sides, a pattern in which a plurality of circles and ellipses are contiguous, or a pattern combining these geometric patterns and circular and elliptical patterns. Furthermore, the shape of the convex portions or concave portions of the regular unevenness in a plan view may be lines or waves. Specific examples of the release film 6 having regular surface unevenness include the product named NEF (embossed film having diamond-shaped surface unevenness) made by Ishijima Chemical Industries Co., Ltd.

Furthermore, in step D, as illustrated in FIG. 5, pressing may be performed while the thermally conductive sheet precursor 7 is sandwiched by the release films 6A and 6B and rubber cushions 8 having a regular pattern are disposed on an outer sides of these release films 6A and 6B, that is, on a laminate having a rubber cushion 8A, the release film 6A, the thermally conductive sheet precursor 7, the release film 6B, and a rubber cushion 8B, in that order. In such an embodiment as well, in addition to obtaining a thermally conductive sheet 1 on which the regular surface pattern described above is formed, tracking (close adhesion) of the release film 6 to the thermally conductive sheet 1 becomes more favorable, and it is possible to effectively express the tack force of the thermally conductive sheet 1. Furthermore, it is also possible to prevent the thermally conductive sheet precursor 7 from adhering to the pressing device when pressing the thermally conductive sheet precursor 7. For example, the plan view pattern of the rubber cushions 8 having a regular pattern may be the same as the regular unevenness described above. Specific examples of the rubber cushions 8 having a regular pattern include the product named YOM-F01 FDRR (rubber cushion having a diamond-shaped surface pattern) made by Yamauchi Co., Ltd.

In step D, as illustrated in FIGS. 4 and 5, the thermally conductive sheet supply form 5 illustrated in FIG. 3 in which the thermally conductive sheet 1 is sandwiched by the release film 6 is obtained by pressing the thermally conductive sheet precursor 7 while sandwiched by the release film 6. The thermally conductive sheet 1 obtained by releasing the release film 6 from this thermally conductive sheet supply form 5 is tacky on both sides, which enables adhesion to the adherend and can prevent misalignment during mounting. Note that the method for pressing the thermally conductive sheet precursor 7 in step D in not limited to the method illustrated in FIGS. 4 and 5 and, for example, may be an embodiment in which the thermally conductive sheet precursor 7 is placed on a stage and only pressed from above the thermally conductive sheet precursor 7. Such a method can also be used to obtain the thermally conductive sheet 1 as in the method illustrated in FIGS. 4 and 5.

For example, when pressing the thermally conductive sheet supply form 5 illustrated in FIG. 3 for three minutes at 90° C. and 0.5 MPa in step D, it is possible to set the difference in tack force of the thermally conductive sheet precursor 7 before and after pressing to four times or more. That is, when pressing the thermally conductive sheet supply form 5 for three minutes at 90° C. and 0.5 MPa, it is possible to set the difference in tack force of the thermally conductive sheet 1 (thermally conductive sheet precursor 7 after pressing) to four times or more the tack force of the thermally conductive sheet precursor 7 before pressing. Thus, due to the tack force of the thermally conductive sheet 1 being four times or more the tack force of the thermally conductive sheet precursor 7 before pressing, for example, it is possible to further improve close adhesion between the thermally conductive sheet 1 and the adherend (for example, an IC) and effectively prevent misalignment of the thermally conductive sheet 1 and the adherend. Furthermore, due to the tack force of the thermally conductive sheet 1 being four times or more the tack force of the thermally conductive sheet precursor 7 before pressing, once the thermally conductive sheet 1 is applied, even when a certain level of vibration is applied thereto, misalignment of the thermally conductive sheet 1 does not readily occur, and thus this is preferable from the perspective of improving workability, productivity, yield, and the like.

<Electronic Device>

The thermally conductive sheet 1 may, for example, be disposed between a heating element and a heat dissipation element to form an electronic device (thermal device) having a structure arranged between them to allow the heat generated by the heating element to pass to the heat dissipation element. The electronic device has at least a heating element, a heat dissipation element, and the thermally conductive sheet 1 and may further have other components as necessary.

The heating element is not particularly limited, and examples include electronic components that generate heat in electric circuitry, including integrated circuit elements such as a CPU (central processing unit), GPU (graphics processing unit), DRAM (dynamic random access memory), and flash memory, transistors, and resistors. Furthermore, heating elements also include components that receive optical signals, such as optical transceivers in telecommunications equipment.

The heat dissipation element is not particularly limited, and examples include those used in combination with integrated circuit elements, transistors, optical transceiver housings, and the like such as heat sinks and heat spreaders. In addition to heat spreaders and heat sinks, heat dissipation elements may be anything that conducts and dissipates heat generated from a heat source to the outside, for example, heat dissipators, coolers, die pads, printed circuit boards, cooling fans, Peltier elements, heat pipes, metal covers, housings, and the like.

FIG. 6 is a sectional view of a semiconductor device to which the thermally conductive sheet of the present art is applied. For example, as illustrated in FIG. 6, the thermally conductive sheet 1 is mounted on a semiconductor device 50 built into various electronic devices and sandwiched between the heating element and the heat dissipation element. The semiconductor device 50 illustrated in FIG. 6 is provided with an electronic component 51, a heat spreader 52, and the thermally conductive sheet 1, and the thermally conductive sheet 1 is sandwiched between the heat spreader 52 and the electronic component 51. Due to the thermally conductive sheet 1 being sandwiched between the heat spreader 52 and a heat sink 53, it, together with the heat spreader 52, constitutes a heat dissipation member that dissipates heat from the electronic component 51. The mounting location of the thermally conductive sheet 1 is not limited to between the heat spreader 52 and the electronic component 51 or between the heat spreader 52 and the heat sink 53 and may be selected as appropriate according to the configuration of the electronic equipment or semiconductor device.

### EXAMPLES

Examples of the present art will be described below. The present art is not limited to these examples.

### Example 1

In example 1, a resin composition for forming a thermally conductive sheet was prepared by uniformly mixing 33% by volume of silicone resin, 27% by volume of boron nitride flakes (D50 of 40 μm) having a hexagonal crystal shape, 20% by volume of aluminum nitride (D50 of 1.2 μm), 19% by volume of alumina particles (D50 of 1 μm), and 1% by volume of a silane coupling agent. The resin composition for forming a thermally conductive sheet was poured into a die (opening: 50 μmm×50 mm) having a rectangular inner cavity via extrusion molding and heated for four hours in a 60° C. oven to form a molded block. Note that a release PET film was attached to the inner surface of the mold such that the release-treated side would be on the inner side. The obtained molded block was sliced into 1 μmm thick sheets using a slicer to obtain a thermally conductive sheet precursor in which the boron nitride flakes are oriented in the sheet thickness direction. The obtained thermally conductive sheet precursor was sandwiched between release-treated PET films and pressed for three minutes at 90° C. and 0.5 MPa. Thus, the thermally conductive sheet of example 1 (thermally conductive sheet supply form in which the thermally conductive sheet is sandwiched by PET films) was obtained.

### Example 2

In example 2, the thermally conductive sheet precursor was obtained by the same method as example 1, aside from preparing the resin composition for forming a thermally conductive sheet by uniformly mixing 37% by volume of silicone resin, 23% by volume of boron nitride flakes (D50 of 40 μm) having a hexagonal crystal shape, 20% by volume of aluminum nitride (D50 of 1.5 μm), 17% by volume of alumina particles (D50 of 1 μm), 1% by volume of aluminum hydroxide (D50 of 8 μm), and 1% by volume of a silane coupling agent. The obtained thermally conductive sheet precursor was sandwiched between release-treated PET films and pressed for three minutes at 90° C. and 0.5 MPa. Thus, the thermally conductive sheet of example 2 (thermally conductive sheet supply form in which the thermally conductive sheet is sandwiched by PET films) was obtained.

### Example 3

In example 3, the thermally conductive sheet precursor was obtained using the same resin composition for forming a thermally conductive sheet as in example 1. The resulting thermally conductive sheet precursor was sandwiched between release-treated PET embossed films having regular unevenness and pressed for three minutes at 90° C. and 0.5 MPa. Thus, the thermally conductive sheet of example 3 (thermally conductive sheet supply form in which the thermally conductive sheet is sandwiched by PET films) was obtained.

### Example 4

In example 4, the thermally conductive sheet precursor was obtained using the same resin composition for forming a thermally conductive sheet as in example 1. The resulting thermally conductive sheet precursor was sandwiched between release-treated PET films, rubber cushions having regular patterns were disposed on the outer side of these PET films, and this was pressed for three minutes at 90° C. and 0.5 MPa. Thus, the thermally conductive sheet of example 4 (thermally conductive sheet supply form in which the thermally conductive sheet is sandwiched by PET films) was obtained.

### Comparative Example 1

In comparative example 1, the thermally conductive sheet precursor was obtained by the same method as example 1. Also, in comparative example 1, the obtained thermally conductive sheet precursor was sandwiched between release-treated PET films. However, in comparative example 1, the obtained thermally conductive sheet precursor was not pressed as in example 1.

### Comparative Example 2

In comparative example 2, the resin composition for forming a thermally conductive sheet was prepared by uniformly mixing 37% by volume of silicone resin, 23% by volume of boron nitride flakes (D50 of 40 μm) having a hexagonal crystal shape, 20% by volume of aluminum nitride (D50 of 1.5 μm), 19% by volume of alumina particles (D50 of 1 μm), and 1% by volume of a silane coupling agent. This resin composition for forming a thermally conductive sheet was used to obtain a thermally conductive sheet precursor by the same method as example 1. Also, in comparative example 2, the obtained thermally conductive sheet precursor was sandwiched between release-treated PET films. However, in comparative example 2, the obtained thermally conductive sheet precursor was not pressed as in example 1.

<Thermal Conductivity>

The thermal conductivities (W/m·K) in the thickness directions of the thermally conductive sheets were each measured. Specifically, a thermal resistance measuring device compliant with ASTM-D5470 was used to apply a load of 1 kgf/cm² to measure the thermal conductivity of the thermally conductive sheet before pressing and after pressing (immediately after pressing). In examples 1 to 4, the thermal conductivity of the thermally conductive sheet supply form before pressing (thermally conductive sheet precursor) and the thermal conductivity of the thermally conductive sheet having the PET film peeled from the thermally conductive sheet supply form after pressing were measured. In comparative examples 1 and 2, the thermal conductivity of the thermally conductive sheet precursor before pressing was measured. The results are shown in Table 1. In Table 1, “-” for thermal conductivity immediately after pressing means that it was not measured because pressing was not performed.

<Specific Gravity>

The specific gravities of the thermally conductive sheets obtained in examples 1 to 4 and the thermally conductive sheet precursors obtained in comparative examples 1 and 2 were determined by measuring the volume obtained from the length, width, and thickness of the sheet and the weight of the thermally conductive sheet. The results are shown in Table 1.

<Securing to Aluminum Plate>

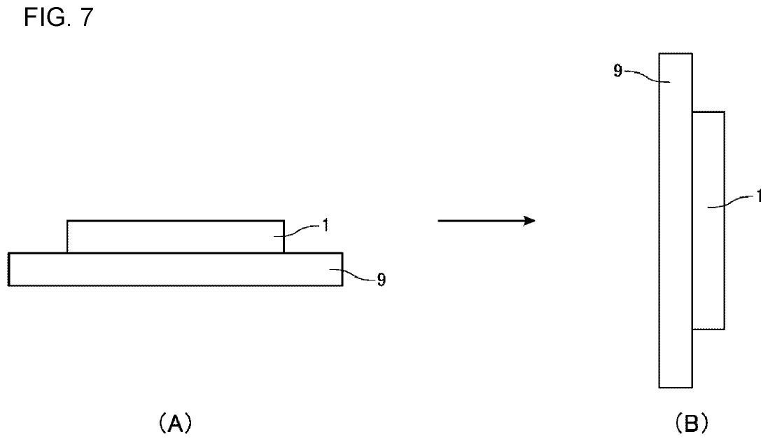

FIG. 7 is a diagram for describing the method for evaluating whether the thermally conductive sheet slides down from an aluminum plate when placed on the aluminum plate and tilting by 90°. After placing the thermally conductive sheet 1 on a horizontally placed aluminum plate 9 as illustrated in FIG. 7(A), it was evaluated whether the thermally conductive sheet 1 slides down from the aluminum plate 9 when the aluminum plate 9 is tilted 900 while holding the thermally conductive sheet 1 as shown in FIG. 7(B). The results are shown in Table 1. In Table 1, “secured by simply placing” indicates that the thermally conductive sheet 1 did not slide down from the aluminum plate 9, and “not secured” indicates that the thermally conductive sheet 1 did slide down from the aluminum plate 9. Note that in examples 1 to 4, the thermally conductive sheet for which the PET film was peeled from the thermally conductive sheet supply form was used as the thermally conductive sheet 1 in FIG. 7, and in comparative examples 1 and 2, the thermally conductive sheet precursor was used.

<Transferring After Peeling Sheet>

The thermally conductive sheet supply forms obtained in examples 1 to 4 were press-treated for 30 seconds at 0.5 MPa, and it was visually checked when the PET film was peeled from this thermally conductive sheet supply form whether traces (white) of the thermally conductive sheet were adhered to this PET film. Furthermore, the thermally conductive sheet precursors sandwiched by PET film obtained in comparative examples 1 and 2 were press-treated for 30 seconds at 0.5 MPa, and it was visually checked when the PET film was peeled from this thermally conductive sheet precursor sandwiched by this PET film whether traces (white) of the thermally conductive sheet precursor were adhered to this PET film. The results are shown in Table 1.

<Sheet Surface>

The surface of the thermally conductive sheets obtained in examples 1 to 4 were visually evaluated. The results are shown in Table 1. In Table 1, “-” for sheet surface means that it was not evaluated because pressing was not performed.

<Tack Force Immediately After Sheeting>

For the obtained thermally conductive sheet precursors, the tack force (gf) on the surface of the thermally conductive sheet precursor when the thermally conductive sheet precursor was pressed in 50 μm at 2 μmm/sec using a 5.1 μmm diameter probe and pulled out at 10 μmm/sec was found. Note that in examples 1 to 4, the thermally conductive sheet precursor after slicing and before pressing was used. The results are shown in Table 1.

<Tack Force After Pressing>

The tack force (gf) on the surface of the thermally conductive sheets (thermally conductive sheet precursor immediately after pressing) obtained in examples 1 to 4 was measured by the following method. After press-treating the thermally conductive sheet supply forms obtained in examples 1 to 4 under the conditions described above, this thermally conductive sheet supply form was further press-treated for 30 seconds at 0.5 MPa, and within three minutes after releasing the PET film from the thermally conductive sheet supply form, the tack force on the surface of the thermally conductive sheet when the thermally conductive sheet was pressed in 50 μm at 2 μmm/sec using a 5.1 μmm diameter probe and pulled out at 10 mm/sec was found. The results are shown in Table 1. In Table 1, “-” for tack force after pressing means that it was not measured because pressing was not performed.

TABLE 1

| | | | | | Comparative | Comparative |
|---|---|---|---|---|---|---|
| | Example 1 | Example 2 | Example 3 | Example 4 | Example 1 | Example 2 |
| Silicone resin | 33 | 37 | 33 | 33 | 33 | 37 |
| [% by volume] | | | | | | |
| Boron nitride flakes | 27 | 23 | 27 | 27 | 27 | 23 |
| D50 = 40 μm | | | | | | |
| [% by volume] | | | | | | |
| Aluminum nitride | 20 | 20 | 20 | 20 | 20 | 20 |
| D50 = 1.5 μm | | | | | | |
| [% by volume] | | | | | | |
| Alumina | 19 | 17 | 19 | 19 | 19 | 19 |
| D50 = 1 μm | | | | | | |
| [% by volume] | | | | | | |
| Zinc oxide | 0 | 1 | 0 | 0 | 0 | 0 |
| D50 = 1 μm | | | | | | |
| [% by volume] | | | | | | |
| Aluminum hydroxide | 0 | 1 | 0 | 0 | 0 | 0 |
| D50 = 8 μm | | | | | | |
| [% by volume] | | | | | | |
| Coupling agent | 1 | 1 | 1 | 1 | 1 | 1 |
| [% by volume] | | | | | | |
| Thermal conductivity | 10.9 | 9.2 | 10.3 | 10.6 | 9.0 | 10.5 |
| before pressing | | | | | | |
| [W/m · k] | | | | | | |
| Thermal conductivity | 9.6 | 8.0 | 9.5 | 9.9 | — | — |
| after pressing | | | | | | |
| [W/m · k] | | | | | | |
| Specific gravity | 2.3 | 2.3 | 2.3 | 2.3 | 2.3 | 2.3 |
| Attachment to | Secured by | Secured by | Secured by | Secured by | Not secured | Not secured |
| aluminum plate | simply | simply | simply | simply | | |
| | placing | placing | placing | placing | | |
| Transfer to PET of | Yes | Yes | Yes | Yes | Yes | Yes |
| components of | | | | | | |
| sheet after PET is | | | | | | |
| peeled | | | | | | |
| Sheet surface | Smooth | Smooth | Regular | Regular | — | — |
| | | | pattern | pattern | | |
| | | | present | present | | |
| Tack force immediately | 20 | 15 | 20 | 20 | 20 | 15 |
| after sheeting | | | | | | |
| [gf] | | | | | | |
| Tack force | 100 | 90 | 90 | 85 | — | — |
| after pressing | | | | | | |
| [gf] | | | | | | |

The thermally conductive sheets obtained in examples 1 to 4 included a binder resin and boron nitride flakes, and the boron nitride flakes were oriented in the thickness direction of the thermally conductive sheet. Furthermore, it was found that both side of the thermally conductive sheets obtained in examples 1 to 4 are tacky. Moreover, it was found that the thermally conductive sheets obtained in examples 1 to 4 were secured when placed on the aluminum plate. This suggested that the thermally conductive sheets in examples 1 to 4 can prevent misalignment during mounting of the thermally conductive sheet.

Conversely, it was found that both sides of the thermally conductive sheet (thermally conductive sheet precursor) were not tacky in comparative examples 1 and 2. This is conceivably because the thermally conductive sheet precursor was not pressed in comparative examples 1 and 2 as in examples 1 to 4.

### DESCRIPTION OF REFERENCE NUMERALS

1 thermally conductive sheet, 2 binder resin, 3 boron nitride flakes, 3A boron nitride flake, a major axis, b thickness, c minor axis, 4 other thermally conductive material, 5 thermally conductive sheet supply form, 6 release film, 7 thermally conductive sheet precursor, 8 rubber cushion, 9 aluminum plate, 50 semiconductor device, 51 electronic component, 52 heat spreader, 53 heat sink

1: A thermally conductive sheet, comprising a binder resin and boron nitride flakes, wherein
the boron nitride flakes are oriented in a thickness direction of the thermally conductive sheet, and both surfaces of the thermally conductive sheet are tacky.

2: The thermally conductive sheet according to claim 1, wherein the thermally conductive sheet has a regular pattern on a surface thereof.

3: A thermally conductive sheet supply form, comprising:
the thermally conductive sheet according to claim 1; and
release films which sandwich the thermally conducive sheet.

4: The thermally conductive sheet supply form according to claim 3, wherein a tack force of the thermally conductive sheet supply form is 80 gf or more, the tack force being measured by:
pressing the thermally conductive sheet supply form at a pressure of 0.5 MPa for 30 seconds;
peeling off the release film from the thermally conductive sheet:
within three minutes after peeling off the release film from the thermally conductive sheet, pressing the thermally conductive sheet with a probe having a diameter of 5.1 μmm at a speed of 2 μmm/second into a depth of 50 μm; and
determining a force when pulling out the probe at a speed of 10 μmm/second as the tack force.

5: The thermally conductive sheet supply form according to claim 3, wherein, when the release film is peeled off from the thermally conductive sheet, part of the binder resin and the boron nitride flakes constituting the thermally conductive sheet are transferred to the release film.

6: The thermally conductive sheet supply form according to claim 3, wherein the thermally conductive sheet further comprises, therein, particles of alumina, aluminum nitride, zinc oxide, aluminum hydroxide, or a combination thereof.

7: The thermally conductive sheet supply form according to claim 3, wherein the thermally conductive sheet consists of one piece of the thermally conductive sheet.

8: The thermally conductive sheet supply form according to claim 3, wherein the thermally conductive sheet comprises plural pieces of the thermally conductive sheet disposed at predetermined intervals laterally and longitudinally.

9: A thermally conductive sheet, which is produced by pressing the thermally conductive sheet supply form according to claim 3, and by peeling off the release film from the thermally conductive sheet of the thermally conductive sheet supply form.

10: An electronic device, comprising the thermally conductive sheet according to claim 1.

11: A thermally conductive sheet precursor, comprising a binder resin and boron nitride flakes, wherein
the boron nitride flakes are oriented in a thickness direction of the thermally conductive sheet precursor, and
a tack force of the thermally conductive sheet precursor after pressing at a pressure of 0.5 MPa at 90° C. for three minutes is at least four times greater than a tack force of the thermally conductive sheet precursor before the pressing, the tack force being measured by:
pressing the thermally conductive sheet precursor with a probe having a diameter of 5.1 μmm at a speed of 2 μmm/second into a depth of 50 μm; and
determining a force when pulling out the probe at a speed of 10 μmm/second as the tack force.

12. (canceled)

13: A method for manufacturing a thermally conductive sheet, comprising:
preparing a thermally conductive composition comprising a binder resin and boron nitride flakes;
forming a molded block from the thermally conductive composition;
slicing the molded block into a sheet shape to obtain a thermally conductive sheet precursor; and
pressing the thermally conductive sheet precursor to obtain a thermally conductive sheet.

14: The method according to claim 13, wherein the thermally conductive sheet has a tack force of at least four times greater than a tack force of the thermally conductive sheet precursor, the tack force being measured by:
pressing the thermally conductive sheet or the thermally conductive sheet precursor with a probe having a diameter of 5.1 μmm at a speed of 2 μmm/second into a depth of 50 μm; and
determining a force when pulling out the probe at a speed of 10 μmm/second as the tack force.

15: The method according to claim 13, wherein a molded block is formed from the thermally conductive composition by extrusion molding.

16: The method according to claim 13, wherein when pressing the thermally conductive sheet precursor, the thermally conductive sheet precursor is sandwiched by release films to obtain a thermally conductive sheet supply form in which the thermally conductive sheet is sandwiched by the release films.

17: An electronic device, comprising the thermally conductive sheet according to claim 2.

18: An electronic device, comprising the thermally conductive sheet according to claim 9.
